(19) United States
(12) Patent Application Publication
(10) Pub. No.: US 2024/0131664 A1
(43) Pub. Date: Apr. 25, 2024

(54) Torque Wrench with Stable Trip Mechanism

(71) Applicant: Shih-Hao Lai, Taichung City, (TW)

(72) Inventor: Shih-Hao Lai, Taichung City, (TW)

(21) Appl. No.: 17/971,742

(22) Filed: Oct. 23, 2022

(51) Int. Cl. B25B 23/142; B25B 23/14

(52) U.S. Cl. CPC B25B 23/1427; B25B 23/141

(57) ABSTRACT

A torque wrench includes a shank and a driving rod. The shank is provided with only one tripping seat therein. One end of the tripping seat is provided with a positioning recess and a restoring surface surrounding the positioning recess. The driving rod is pivotally inserted into the shank and movable between a ready position and a tripping position. One end of the driving rod is provided with an abutting portion having a spherical surface. The abutting portion abuts against the positioning recess when the driving rod is in the ready position. The abutting portion is separated from the positioning recess and abuts against the restoring surface when the driving rod is in the tripping position.

### BACKGROUND

The present invention relates to a torque wrench and, more particular, to a torque wrench, which has a stable trip mechanism.

Taiwan Patent No. TWI701110 discloses a torque structure, which includes: a first body provided with a first accommodating groove; a second body provided with a second accommodating groove, a first wall surface, a second wall surface, a first pivot part and a first joint part; a pushing member provided with an accommodating groove; a first elastic member; a jumper block; an adjustment set; a third body provided with a driving part, a pivot seat, a second pivot part, a first screwing part and a pushing part; and a first screwing member provided with a first abutting part. The first abutting part slightly protrudes out of the first screwing part, and the first abutting part is aligned with the first wall surface. When the torsion structure is rotated clockwise and the rotating torque reaches a set value, the third body is shifted in the second accommodating groove, so that the first abutting parts hits the first wall surface and emits a prompt sound.

However, the jumper block of the torsion structure is in the shape of a square. When the rotational torque reaches the set value, the jumper block must be turned over to make the third body sway and hit the first wall surface. After the torque is released, the jumper block cannot be ensured to return to a same position under the action of friction, resulting in an error in the torque value every time the jumper block turned over, and it is impossible to accurately trip and turn at the torque set value.

Thus, a need exists for a torque wrench to mitigate and/or obviate the above disadvantages.

### SUMMARY

An objective of the present invention is to provide a torque wrench including a shank and a driving rod. The shank is provided with only one tripping seat therein. One end of the tripping seat is provided with a positioning recess and a restoring surface surrounding the positioning recess. An inner periphery of the restoring surface adjacent to the positioning recess forms an inner edge, and an outer periphery of the restoring surface away to from the positioning recess forms an outer edge. The shank defines a virtual reference plane passing through the positioning recess in a radial direction thereof. A first height is formed from the inner edge to the reference plane in an axial direction of the shank, and a second height is formed from the outer edge to the reference plane in the axial direction of the shank. The second height is greater than the first height. The driving rod is pivotally inserted into the shank and movable between a ready position and a tripping position. One end of the driving rod is provided with an abutting portion having a spherical surface. The abutting portion abuts against the positioning recess when the driving rod is in the ready position. The abutting portion is separated from the positioning recess and abuts against the restoring surface when the driving rod is in the tripping position.

In an embodiment, a distance from the restoring surface to the reference plane in the axial direction of the shank gradually increases from a position adjacent to the inner edge to a position adjacent to the outer edge.

In an embodiment, the restoring surface is in the shape of a conical surface.

In an embodiment, the end of the driving rod provided with the abutting portion is further provided with a containing recess and a tripping member. The tripping member is a ball. A first side of the tripping member is arranged in the containing recess, and a second side of the tripping member protrudes from the containing recess. The abutting portion is arranged on the second side of the tripping member.

In an embodiment, the tripping member defines a ball diameter. The to inner edge is circular and defines a hole diameter in the radial direction of the shank. The hole diameter is less than the ball diameter.

The present invention will become clearer in light of the following detailed description of illustrative embodiments of this invention described in connection with the drawings.

### BRIEF DESCRIPTION OF THE DRAWINGS

FIG. 1 is a perspective view of a torque wrench of an embodiment according to the present invention.

FIG. 2 is an exploded perspective view of the torque wrench of FIG. 1.

FIG. 3 is another exploded perspective view of the torque wrench of FIG. 1.

FIG. 4 is a cross sectional view of the torque wrench of FIG. 1 and shows the driving rod disposed in the ready position.

FIG. 5 is another cross sectional view of the torque wrench of FIG. 11 and shows the driving rod disposed in the tripping position.

### DETAILED DESCRIPTION

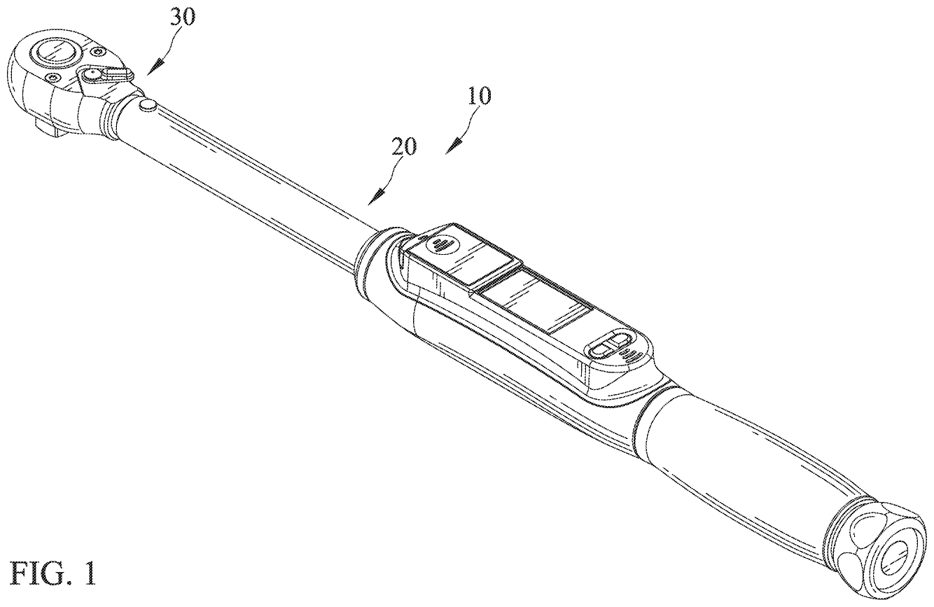

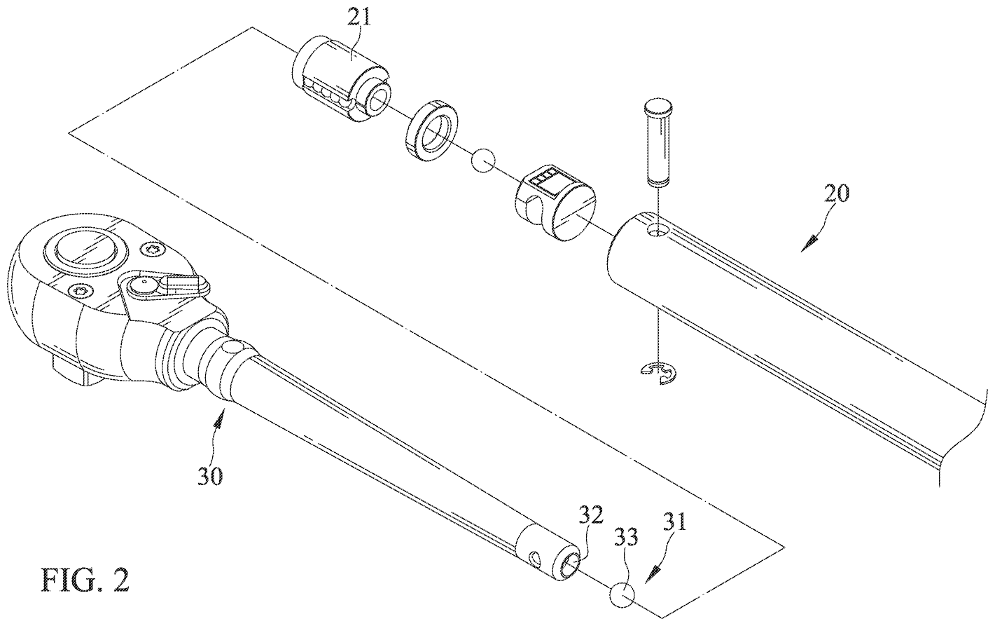

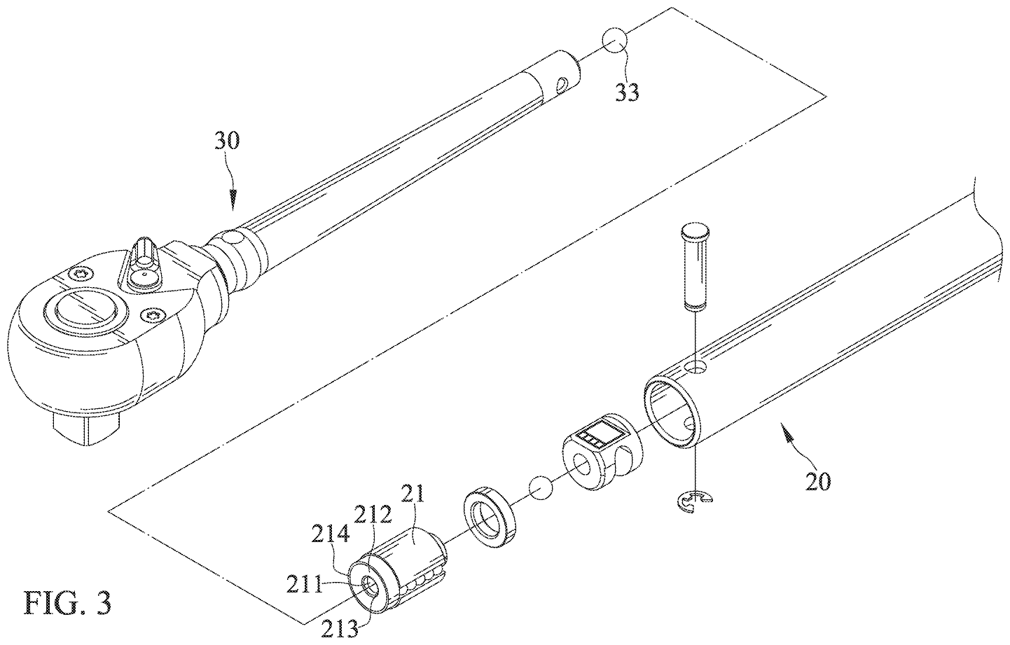

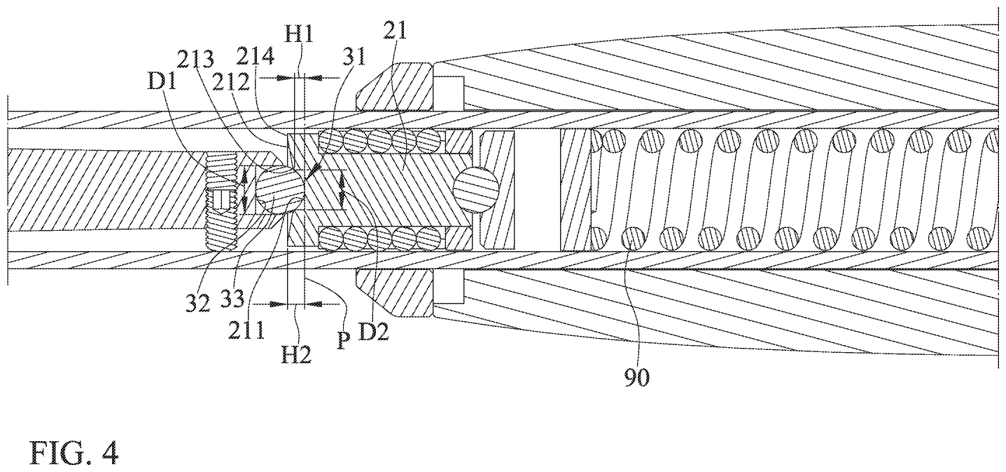

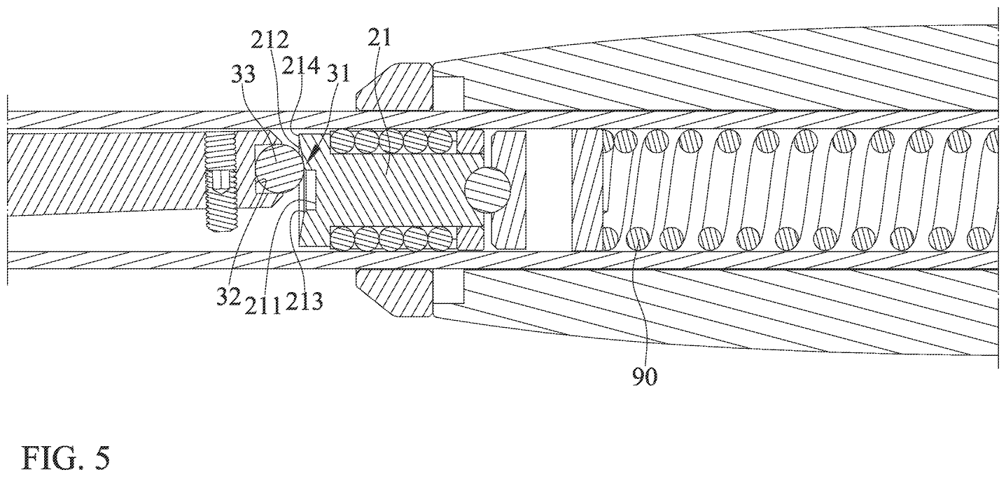

FIGS. 1-5 show a torque wrench 10 of an embodiment according to the present invention. The torque wrench 10 includes a shank 20 and a driving rod 30.

The shank 20 is provided with only one tripping seat 21 therein. One end of the tripping seat 21 is provided with a positioning recess 211 and a restoring surface 212 surrounding the positioning recess 211. An inner periphery of the restoring surface 212 adjacent to the positioning recess 211 forms an inner edge 213, and an outer periphery of the restoring surface 212 away from the positioning recess 211 forms an outer edge 214. The shark 20 defines a virtual reference plane P passing through the positioning recess 211 in a radial direction thereof. A first height H1 is formed from the inner edge 213 to the reference plane P in an axial direction of the shank 20, and a second height H2 is formed from the outer edge 214 to the reference plane P in the axial direction of the shank 20. Further, the second height H2 is greater than the first height H1.

The driving rod 30 is pivotally inserted into the shank 20 and movable between a ready position and a tripping position. Further, the driving rod 30 has an abutting end, which is provided with an abutting portion 31 with a spherical surface.

The abutting portion 31 abuts against the positioning recess 211 when the driving rod 30 is in the ready position. The abutting portion 31 is separated from the positioning recess 211 and abuts against the restoring surface 212 when the driving rod 30 is in the tripping position.

Further, a distance from the restoring surface 212 to the reference plane P in the axial direction of the shank 20 gradually increases from a position adjacent to the inner edge 213 to a position adjacent to the outer edge 214. In addition. The restoring surface 212 may be in the shape of a conical surface or spherical concave convex surface. In the embodiment, the restoring surface 212 is a conical surface.

The abutting end of the driving rod 30 is further provided with a containing recess 32 and a tripping member 33. The tripping member 33 in this embodiment is a ball. A first side of the tripping member 33 is arranged in the containing recess 32, and a second side of the tripping member 33 protrudes from the containing recess 32, and the abutting portion 31 is arranged on the second side of the tripping member 33.

Further, the tripping member 33 defines a ball diameter D1. The inner edge 213 is circular and defines a hole diameter D2 in the radial direction of the shank 20. The hole diameter D2 is less than the ball diameter D1.

Thus, the torque wrench 10 can provide a stable tripping mechanism with stable effect. The tripping seat 21 is biased by the spring 90 to abut against the abutting portion 31 with a predetermined pushing force. When the driving rod 30 turns a driven object, the driving rod 30 is disposed in the ready position if the torsion force applied on the driving rod 30 is less than the predetermined tripping torque. Once the torsion force applied on the driving rod 30 is greater than the predetermined tripping torque, the driving rod 30 abuts against the tripping seat 21 to move and compress the spring during the pivoting process to cause the abutting portion 31 is separated from the positioning recess 211 to achieve the tripping effect. By the spherical surface of the abutting portion 31, the relative contact between the abutting portion 31 and the positioning recess 211 will not generate a positional error. Thus, the torque wrench 10 can complete the tripping action every time when the driving rod 30 is applied with the preset tripping torque. In addition, the abutting portion 31 can roll or slide on the restoring to surface 212 to cooperate with the pushing force from the spring 90, make the driving rod 30 return to the ready position to provide a restoring effect.

Although specific embodiments have been illustrated and described, numerous modifications and variations are still possible without departing from the scope of the invention. The scope of the invention is limited by the accompanying claims.

1. A torque wrench comprising:
a shank provided with only one tripping seat therein, wherein one end of the tripping seat is provided with a positioning recess and a restoring surface surrounding the positioning recess, wherein an inner periphery of the restoring surface adjacent to the positioning recess forms an inner edge, wherein an outer periphery of the restoring surface away from the positioning recess forms an outer edge, wherein the shank defines a virtual reference plane passing through the positioning recess in a radial direction thereof, wherein a first height is formed from the inner edge to the reference plane in an axial direction of the shank, wherein a second height is foi med from the outer edge to the reference plane in the axial direction of the shank, and wherein the second height is greater than the first height; and
a driving rod pivotally inserted into the shank and movable between a ready position and a tripping position, wherein one end of the driving rod is provided with an abutting portion having a spherical surface, wherein the abutting portion abuts against the positioning recess when the driving rod is in the ready position, and wherein the abutting portion is separated from the positioning recess and abuts against the restoring surface when the driving rod is in the tripping position.

2. The torque wrench as claimed in claim 1, wherein a distance from the restoring surface to the reference plane in the axial direction of the shank gradually increases from a position adjacent to the inner edge to a position adjacent to the outer edge.

3. The torque wrench as claimed in claim 2, wherein the restoring surface is ire the shape of a conical surface.

4. The torque wrench as claimed in claim 1, wherein the end of the driving rod provided with the abutting portion is further provided with a containing recess and a tripping member, wherein the tripping member is a ball, wherein a first side of the tripping member is arranged in the containing recess, and a second side of the tripping member protrudes from the containing recess, and wherein the abutting portion is arranged on the second side of the tripping member.

5. The torque wrench as claimed in claim 4, wherein the tripping if member defines a ball diameter, wherein the inner edge is circular and defines a hole diameter in the radial direction of the shank, and wherein the hole diameter is less than the ball diameter.
